(19) United States
(12) Patent Application Publication
(10) Pub. No.: US 2024/0027784 A1
(43) Pub. Date: Jan. 25, 2024

(54) METHODS FOR ABERRATION CORRECTION IN HIGH NUMERICAL APERTURE OPTICAL SYSTEMS

(71) Applicant: II-VI Delaware, Inc., Wilmington, DE (US)

(72) Inventors: Jonathan PLUMRIDGE, Sydney (AU); Luke STEWART, Gladesville (AU); Glenn BAXTER, Hornsby Heights (AU)

(21) Appl. No.: 18/350,511

(22) Filed: Jul. 11, 2023

Related U.S. Application Data
(60) Provisional application No. 63/391,169, filed on Jul. 21, 2022.

(51) Int. Cl. G02B 27/42; G02B 5/18

(52) U.S. Cl. CPC G02B 27/4211; G02B 5/1814; G02B 5/1828

(57) ABSTRACT

Described herein is a wavelength dispersive optical system (10). The system (10) comprises at least one optical input (12, 14, 16) for projecting an input optical beam comprising a plurality of individual wavelength components and at least one optical output (18) for receiving one or more output optical beams. The system (10) also includes a diffractive optical element (DOE) (1) including a substrate (2) and an array of physical diffraction elements (3). The diffraction elements (3) have a predefined spacing and/or curvature across a length of the DOE (1) and are collectively adapted to: i) spatially separate the individual wavelength components within the input optical beam to be formed into the one or more output optical beams; ii) impose predefined phase changes to the wavelength components to at least partially correct for optical aberrations to the input optical beam; and iii) impose predefined phase changes to the wavelength components to apply a wavelength dependent optical focusing to at least some of the wavelength components. The system (10) further includes an optical focusing element (5) having optical focusing properties complementary to the DOE (1) to modify the wavelength-dependent optical focusing of the wavelength components by the DOE (1).

### CROSS-REFERENCE TO RELATED APPLICATIONS

The present application claims priority to U.S. Provisional Application No. 63/391,169 filed Jul. 21, 2022. The aforementioned application is hereby incorporated by reference in its entirety.

### FIELD OF THE DISCLOSURE

The present application relates to optical devices and in particular to dispersive optical systems.

Embodiments of the present disclosure are particularly adapted for correcting aberrations in wavelength selective switch (WSS) devices used for switching wavelength channels between different optical ports. However, it will be appreciated that the disclosure is applicable in broader contexts and other applications.

### BACKGROUND

Optical systems inherently suffer loss in signal information due to various forms of optical aberration. In smaller, simpler optical devices, beams can be propagated along trajectories closely parallel to the optical axis. In these “paraxial” configurations, aberrations are small and can generally be ignored in practice. However, as more complex devices are built to perform advanced functions, the need to propagate beams off-axis and outside the paraxial region is becoming increasingly important. In these “higher order optics” situations, a number of optical aberrations become more distinct. In particular, off-axis curvature of the focal plane of optical elements becomes a concern. So too do spherical aberration and optical coma.

The degree of the aberrations is generally related to the size and profile of the optical beams in the system. In wavelength selective switch (WSS) devices it is often advantageous to reshape the beam profile to be highly asymmetric. For example, in liquid crystal on silicon (LCOS) based switches, elongated beam profiles are advantageous for efficiently switching many wavelength channels simultaneously. Larger and more asymmetric beams generally experience higher aberrations than smaller symmetric beams.

The off-axis nature of certain WSS designs means that the beam spot incident onto the switching engine (LCOS, MEMs minors, etc.) can have significant aberrations, including optical coma. As the push for smaller beam spots at the switching plane to achieve sharper channels increases, these aberrations limit the potential of these off-axis systems.

U.S. Pat. No. 10,310,148 entitled “Systems and methods of aberration correction in optical systems” discloses the use of a diffraction grating having diffraction elements designed to at least partially correct for optical aberrations. However, this solution has limitations in high numerical aperture systems, where either total spectral width or channel resolution is pushed. In these systems, aberrations increase and it becomes more difficult to maintain spot with acceptable aberrations across all wavelengths.

Any discussion of the background art throughout the specification should in no way be considered as an admission that such art is widely known or forms part of common general knowledge in the field.

### SUMMARY OF THE DISCLOSURE

In accordance with a first aspect of the present disclosure, there is provided a wavelength dispersive optical system, comprising:
at least one optical input for projecting an input optical beam comprising a plurality of individual wavelength components;
at least one optical output for receiving one or more output optical beams;
a diffractive optical element (DOE) including a substrate and an array of physical diffraction elements, wherein the diffraction elements have a predefined spacing and/or curvature across a length of the DOE and wherein the diffraction elements are collectively adapted to:
   i) spatially separate the individual wavelength components within the input optical beam to be formed into the one or more output optical beams;
   ii) impose predefined phase changes to the wavelength components to at least partially correct for optical aberrations to the input optical beam; and
   iii) impose predefined phase changes to the wavelength components to apply a wavelength-dependent optical focusing to at least some of the wavelength components; and
an optical focusing element having optical focusing properties complementary to the DOE to modify the optical focusing of the wavelength components imparted by the DOE.

In some embodiments, the optical focusing element is adapted to modify the optical focusing of the wavelength components to at least partially reverse the optical focusing by the DOE. In some embodiments, the optical focusing element is adapted to provide wavelength-independent optical focusing of the wavelength components. In some embodiments, the optical focusing element is adapted to provide wavelength-dependent optical focusing of the wavelength components.

In some embodiments, the optical focusing element is a cylindrical lens. In other embodiments, the optical focusing element is a spherical lens. In further embodiments, the optical focusing element is an aspherical lens. In still further embodiments, the optical focusing element includes a freeform optical element. In another embodiment, the optical focusing element includes a second DOE.

In some embodiments, the wavelength dispersive optical system is in the form of a wavelength selective switch.

In some embodiments, the DOE provides a divergent optical focusing to the wavelength components and the optical focusing element provides a convergent optical focusing to the wavelength components.

In some embodiments, the optical focusing element is located at a predefined position relative to the DOE. The predefined position may be chosen such that a particular one or more wavelength components are collimated by the optical focusing element.

In some embodiments, the DOE is a diffraction grating. In some other embodiments, the DOE is a grating-prism (grism) element.

In some embodiments, the diffraction elements are arranged in a chirped configuration along the length of the DOE.

### BRIEF DESCRIPTION OF THE FIGURES

Example embodiments of the disclosure will now be described, by way of example only, with reference to the accompanying drawings in which:

FIG. 1 schematically illustrates an exemplary DOE having a phase profile configured to correct for optical aberrations;

FIG. 2 schematically illustrates an alternate exemplary DOE having a phase profile configured to correct for optical aberrations;

FIG. 3 schematically illustrates a DOE and lens combination and exemplary optical ray trajectories corresponding to different wavelength components;

FIG. 4 schematically illustrates the optical layout of an exemplary WSS device;

FIG. 5 illustrates a graph of three exemplary optical transfer functions of 8 GHz, 12 GHz, and 16 GHz respectively;

FIG. 6 illustrates irradiance (power) and phase graphs of the beam spot in the image plane of an exemplary model WSS device;

FIGS. 7A-7C schematically illustrate a DOE and lens combination and exemplary optical ray trajectories illustrating degrees of focus or defocus;

FIG. 8A is a graph of focus displacement from an image plane as a function of wavelength for a system without aberration correction;

FIG. 8B is a graph of focus displacement from an image plane as a function of wavelength for a system incorporating aberration correction; and

FIG. 9 illustrates an exemplary process flow of the steps performed to determine a required phase profile for DOE and lens characteristics which compensate for aberrations in an optical system and reduces wavelength-dependent optical focusing.

### DESCRIPTION OF THE DISCLOSURE

Embodiments of the disclosure will be described herein with specific reference to correcting optical aberrations in wavelength selective switch (WSS) devices. However, the person skilled in the art will appreciate that the principles described herein apply to other dispersive optical systems and devices such as spectrometer devices.

### General Overview

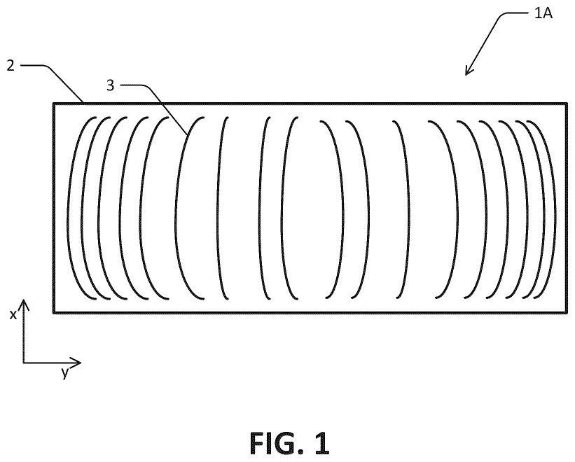

Referring to FIG. 1, there is illustrated schematically a DOE 1A for use in a dispersive optical system. The DOE includes a substrate 2 and an array of elongated diffracting elements 3 arranged across substrate 2. The substrate may comprise a combination of dielectric, semiconductor, or metallic layers. Exemplary diffracting elements are diffraction lines and include grooves or ridges for a reflective grating or slots for a transmissive grating. In a conventional diffraction grating, the diffraction lines, grooves, ridges, or slots are physically etched or cut from one or more of the substrate layers. Each of the diffracting elements includes a relative degree of curvature across the face of grating 1A (including zero curvature). The DOE is made up of a well-defined arrangement of all the individual diffractive elements, which imparts a predefined phase change to incident optical beams to at least partially correct the beams for optical aberrations present in the optical system.

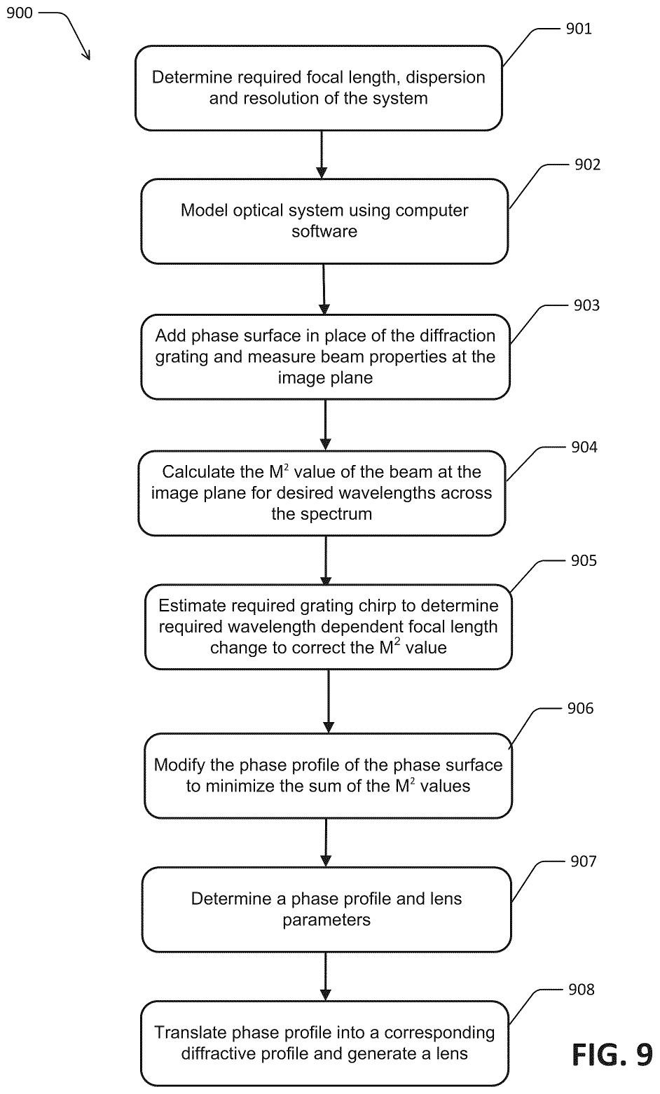

The phase profile imparted by DOE 1 is defined based on the optical aberrations to the optical beams that propagate through the optical system and is different for each optical system. The amount and type of optical aberrations in the optical system are determined through an initial measurement procedure described below and illustrated in FIG. 9. The spacing of adjacent elements 3 varies as a function of position across substrate 2 in the diffraction dimension (y-axis) based on the optical aberrations measured in the initial procedure. Furthermore, diffracting elements 3 have a curvature that also varies across substrate 2 in the diffraction dimension based on the optical aberrations measured in the initial procedure.

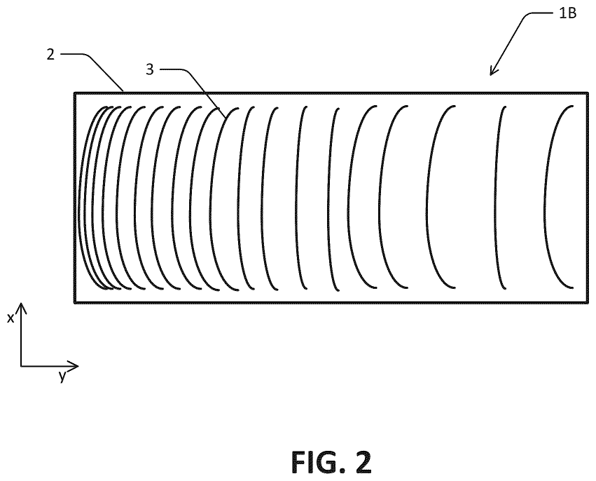

Referring now to FIG. 2, there is illustrated an alternate DOE 1B for use in a dispersive system. DOE 1B is similar to that of DOE 1A, however, the diffracting elements 3 are arranged in a chirped arrangement in which the spacing between the elements is small on the left side of substrate 2 and larger on the right side of substrate 2. Thus, the period of diffracting elements 3 varies along the length of substrate 2. The change in periodicity may vary linearly or nonlinearly. In conjunction, the relative curvature of the diffracting elements 3 may vary with the periodicity or independently of the change in periodicity. It will be appreciated that various DOE profiles may be defined, each having relative degrees of chirp and curvature profiles of diffracting elements 3. This chirp is one way to create focusing power within the beam, which has a wavelength dependence.

The overall effect of the DOE is to impose predefined phase changes to the wavelength components to at least partially correct for optical aberrations to the input optical beam. However, the nature of the phase changes also inherently provides a wavelength-dependent optical focusing to at least some of the wavelength components. This wavelength-dependent optical focusing results in the wavelength components that are dispersed from DOE 1 being focused at different points along the optical axis.

The DOE device 1 may also be incorporated as the grating in a grating-prism (grism) element which comprises a diffraction grating mounted to or integrated onto a prism.

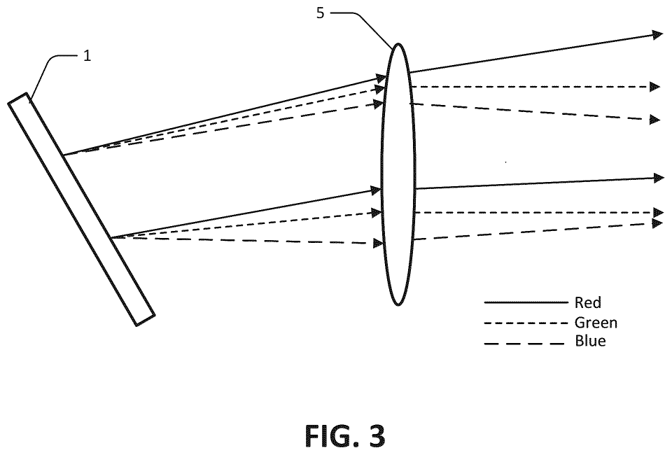

Referring now to FIG. 3, to at least partially reverse the wavelength-dependent optical focusing of the wavelength components by DOE device 1, an optical focusing element 5 having optical focusing properties complementary to the DOE device 1 is implemented. In some embodiments, element 5 includes a cylindrical lens. In other embodiments, element 5 includes a spherical lens, aspherical lens, and/or a freeform optical element. The characteristics and position of element 5 are selected based on the amount and type of optical aberrations in the optical system, in combination with the phase profile of DOE device 1, and are determined through an initial measurement procedure described below and illustrated in FIG. 9.

Depending on the nature of the optical system, a single or double pass of lens element 5 may be performed. In any system, at least a single pass of element 5 is required, but in some systems (like transmissive systems) element 5 may be used on either the input or output.

In operation, the DOE device 1 is positioned within a dispersive optical system to provide the required dispersion for that system. The phase profile (defined by the spacing and curvature of the diffracting elements) of the DOE 1 is defined based on the desired dispersive properties of the system and also the optical aberrations, as modeled by modeling software. The optical focusing element 5 is defined to have predefined characteristics and be located at a predefined position within the optical system to modify the optical focusing of the wavelength components by DOE device 1. In some embodiments, the optical focusing element is wavelength dependent while, in other embodiments, it is wavelength independent. In some embodiments, the modifying of the optical focusing includes at least partially reversing the wavelength-dependent optical focusing of the wavelength components by DOE device 1. Example characteristics of element 5 that can be defined include a radius of curvature, material refractive index, dispersive properties, and position in the optical system.

The operation of DOE 1 and optical focusing element 5 in the context of a WSS device is described below.

### Overview of Exemplary WSS Framework

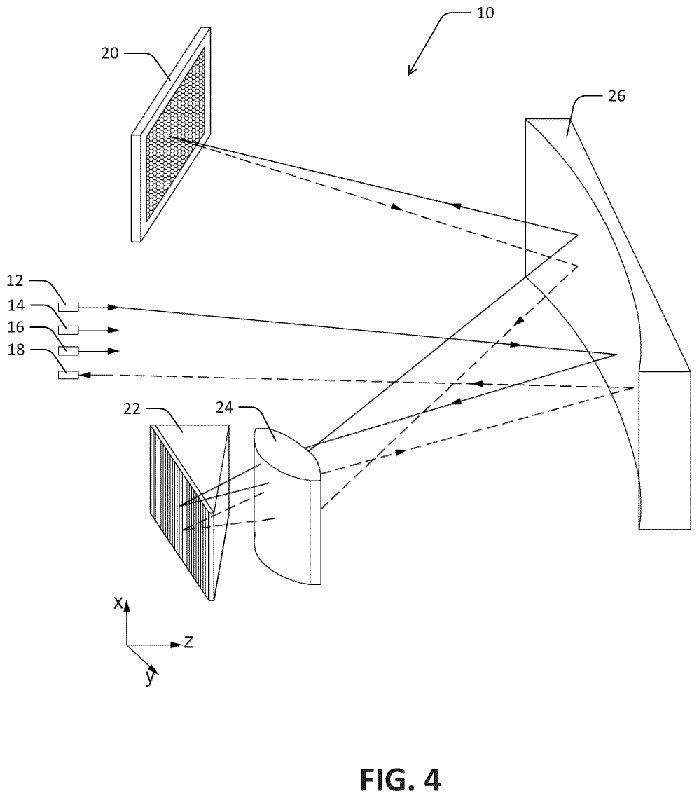

With reference to FIG. 4, a general overview of WSS devices will now be described. FIG. 4 illustrates schematically an exemplary WSS device 10 configured for switching input optical beams from three input optical fiber ports 12, 14, and 16 to an output optical fiber port 18. It will be appreciated that device 10 is reconfigurable such that input ports 12, 14, and 16 can be used as outputs and output port 18 used as an input. The optical beams are indicative of wavelength division multiplexed (WDM) optical signals, which include a plurality of individual optical channels across a region of the electromagnetic spectrum. On a broad functional level, device 10 performs a similar switching function to that described in U.S. Pat. No. 7,397,980 to Frisken, entitled “Dual-source optical wavelength processor” and assigned to II-VI Delaware Inc., the contents of which are incorporated herein by way of cross-reference. The optical beams propagate from input ports 12, 14, and 16 in a forward direction and are reflected from an active switching element in the form of a liquid crystal on silicon (LCOS) device 20 (described below) in a return direction to output port 18. In other embodiments, other types of active switching elements are used in place of LCOS device 20, including arrays of individually controllable micro-electromechanical (MEMs) mirrors.

Device 10 includes a DOE in the form of grism element 22 for spatially dispersing the individual wavelength channels from an input optical beam in the direction of a first axis (y-axis). It will be appreciated by persons skilled in the art that the DOE is not limited to a grism configuration, but may be any type of dispersive or diffractive optical element. By way of example, the DOE may be implemented in the form of a metasurface and/or other optical elements or combinations thereof. Grism element 22 operates in a manner described in U.S. Pat. No. 7,397,980. That is, to spatially separate the constituent wavelength channels contained within each optical beam in the y-axis according to wavelength. However, grism element 22, in addition to the dispersive function, also at least partially corrects beams for optical aberrations present in device 10. As such, grism element 22 can function as the DOE device 1 of FIGS. 1 to 3 as described above.

A lens 24 is positioned adjacent to grism 22 such that the optical beams traverse the lens both before incidence onto grism 22 and after reflection from the grism. This double pass of lens 22 acts to partially reverse some of the phase terms that were imparted by the grism 22 in the y-axis. The total effect of lens 24 and grism 22 is that there is no average focusing across wavelength, but the majority of the wavelength-dependent focusing imparted by the DOE is preserved. Similarly, in propagating between input ports 12, 14, and 16 and LCOS device 20, the beams reflect twice off a cylindrical mirror 26. Mirror 26 has appropriate curvature such that each dispersed channel is focused to the desired location on the LCOS device in the y-axis.

The dispersed wavelength channels are incident onto LCOS device 20, which acts as a reflective spatial light modulator to actively independently steer each channel in the x-axis. At the device level, LCOS device 20 operates in a similar manner to that described in U.S. Pat. No. 7,092,599 to Frisken, entitled “Wavelength manipulation system and method” and assigned to II-VI Delaware Inc., the contents of which are incorporated herein by way of cross-reference. As mentioned above, in other WSS designs, other types of switching elements are used in place of LCOS device 11, such as microelectromechanical minor (MEMs) arrays.

### Overview of Aberrations in WSS Devices

In the frequency domain, optical devices can be characterized in terms of a bandpass filter shape that describes the filtering effects that a device imposes on optical beams. The bandpass filter generated by a WSS can be expressed as the convolution of the aperture formed at the image plane with the beam size in frequency space (known as the optical transfer function) of the device. In modeling an optical system, the aperture is typically chosen to be a rectangular function, and so any features in the overall filter shape are generally defined by the optical transfer function, which is in turn defined by the shape of the focused beam spot in the frequency dispersed axis.

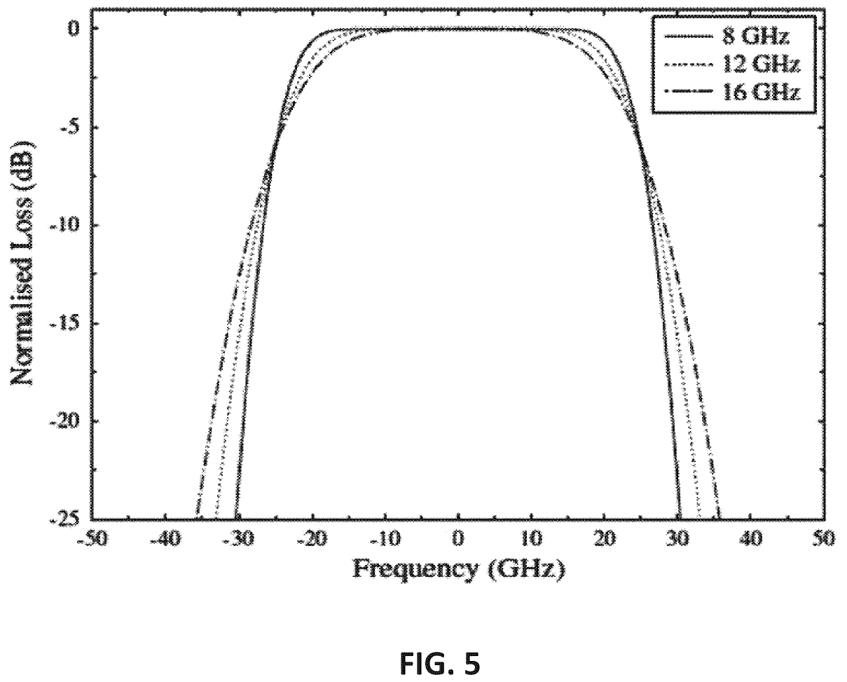

Since conventional WSS systems use single-mode optical fiber inputs, an ideal aberration-free WSS should also have a beam spot with a Gaussian distribution at the image plane. This will create a well-defined, symmetric, bandpass filter where the sharpness of the edges is determined by the size of the spot in the image plane. FIG. 5 illustrates three exemplary optical transfer functions of 8 GHz, 12 GHz, and 16 GHz respectively. Here, the spot size is referenced to the dispersion of the device.

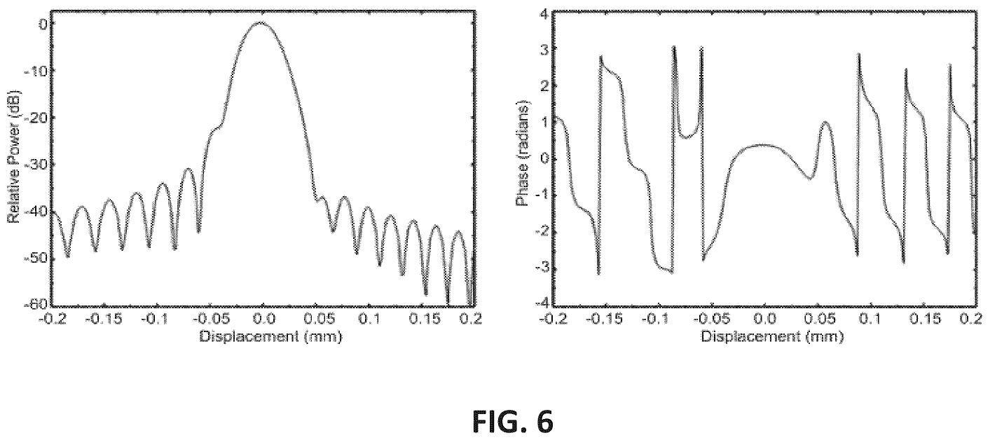

When optical aberrations are taken into account in the system, the beam spot deviates from a perfect Gaussian, and these imperfections are mirrored in the shape of the corresponding filter shape of the device. The imperfections in filter shape arising from optical aberrations degrade the system performance for parameters such as the optical filter width. FIG. 6 illustrates modeled irradiance (power) and phase plots of the spot in the image plane of an exemplary WSS device (modeled in the Zemax OpticStudio optical modeling software). The majority of the irradiance is observed to lie between ±0.05 mm. Over the same range in the phase profile, a sharp feature at the left edge is observed, which corresponds to a side lobe in the irradiance profile. These features, caused by the optical aberrations, affect the resulting filter shape that is defined by the beam spot (optical transfer function).

Examples of optical aberrations commonly experienced in WSS devices include spherical aberration and optical coma. Spherical aberration arises from the imperfect focusing of curved lenses and mirrors. Optical rays that strike the periphery of a lens or mirror are focused to a closer point than rays passing through the center of the lens/mirror. Therefore, spherical aberration is realized as a radial position-dependent focusing. Optical coma occurs when optical rays strike a mirror or lens at an angle to the optical axis or at off-axis positions. The result is that individual rays experience a variation in magnification over the optical element and the rays are not focused to the same point in the image plane. In WSS device 10 of FIG. 4, the coma is dominant as the system has a strong off-axis nature, where the beam strikes the mirror 26 away from the center of curvature twice before it strikes the image plane. Spherical aberration is also present to a lesser extent.

WSS device 10 of FIG. 4 uses a single mirror design, which is advantageous for maintaining a small optical footprint and reducing the number and complexity of components. However, this design uses cylindrical mirror 26 in an off-axis configuration, which leads to coma aberrations on the beam (as well as a spherical aberration that will generally be present in these systems). In some cases, system designers are willing to incur the loss in optical performance associated with these aberrations. However, in more sensitive optical systems, there is a desire to more tightly control the aberrations to reduce these penalties.

Two-mirror WSS systems (such as the Czerny-Turner monochromator approach) can passively compensate for coma effects by undoing the aberrations of a first mirror with a pass of the second mirror. However, these types of systems have disadvantages associated with additional alignment complexity, larger optical footprint, and increased cost.

The present disclosure allows for aberration correction into a single mirror, off-axis WSS system, such as that illustrated in FIG. 4, by adding or modifying existing elements of the system that essentially undoes aberrations on the beam and pre-biases negative aberrations for those predicted further along the optical path. Embodiments of the disclosure described herein incorporate the phase correction into the DOE element (e.g. grism 22) and lens 24, where changes to the diffracting element spacing of the DOE can create a phase profile on the optical beam. It will be appreciated that, in some embodiments, certain aspects of phase correction can also be incorporated in other ways such as programming a phase function into LCOS device 20.

### Description of Aberration Correction Diffraction Grating and Lens Correction

To achieve aberration correction in a WSS system, the present disclosure utilizes a DOE having a phase profile that is specified based on the optical aberrations present in the optical system (WSS device) as well as a lens element which together provide wavelength-dependent optical focusing to the wavelength channels. In the case of device 10 of FIG. 4, the well-defined profile of diffractive elements of grism 22 is specified to impart a predefined phase change to optical beams to at least partially correct the beams for optical aberrations present in the optical system. In particular, the shape and spacing of adjacent diffraction elements is a function of position across the substrate in the dispersive dimension according to a variation profile that is based on the amount of optical aberration in the optical system. In addition, the DOE imposes predefined phase changes to the wavelength components to apply a wavelength-dependent optical focusing to at least some of the wavelength components. This may be by applying a chirp to the periodicity of the diffracting elements 3, as described above. Furthermore, the characteristics of cylindrical lens 24 are varied to provide optical focusing properties complementary to the grism 22 to modify or partially reverse the optical focusing of the wavelength components imparted by grism 22.

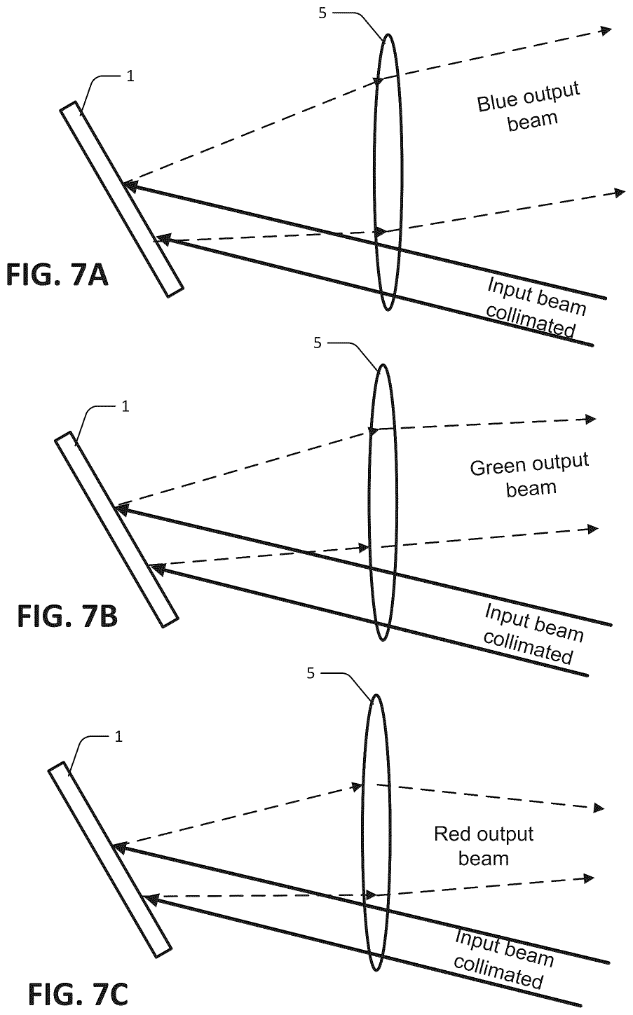

Referring to FIG. 7, which shows two exemplary ‘fields’ for each wavelength (red, green, and blue). The two fields can either represent parts of a single beam or two separate independent beams. FIG. 7A illustrates the fields of a blue wavelength, which are slightly diverging after a double pass of focusing element 5, and reflection from DOE 1. FIG. 7B illustrates the fields of a green wavelength, which are collimated for the same path and FIG. 7C illustrates the fields of a red wavelength, which are slightly converged. As illustrated in FIG. 7, the characteristics of DOE device 1 (or grism 22) and element 5 (or lens 24) can be configured and the elements positioned in the system such that a central (or other arbitrary) wavelength has zero net correction (collimated fields), larger wavelengths have a small positive focus correction (converging fields) and shorter wavelengths have a small negative focus correction (diverging fields). However, in other embodiments, the characteristics of DOE device 1 and element 5 can be configured to perform the opposite—to apply a positive focus to smaller wavelengths and a negative focus to larger wavelengths. In general, the characteristics can be tailored such that the desired wavelength-dependent focusing is achieved for the system.

In the context of a WSS device, the optical focusing power of lens 24, as well as position relative to the grism 22, can be optimized to significantly improve the wavelength and field-dependent overlap at the switching engine of the WSS. In some embodiments, the optical focusing power of lens 24 is defined by the radius of curvature, shape, refractive index, material properties, and location of the lens.

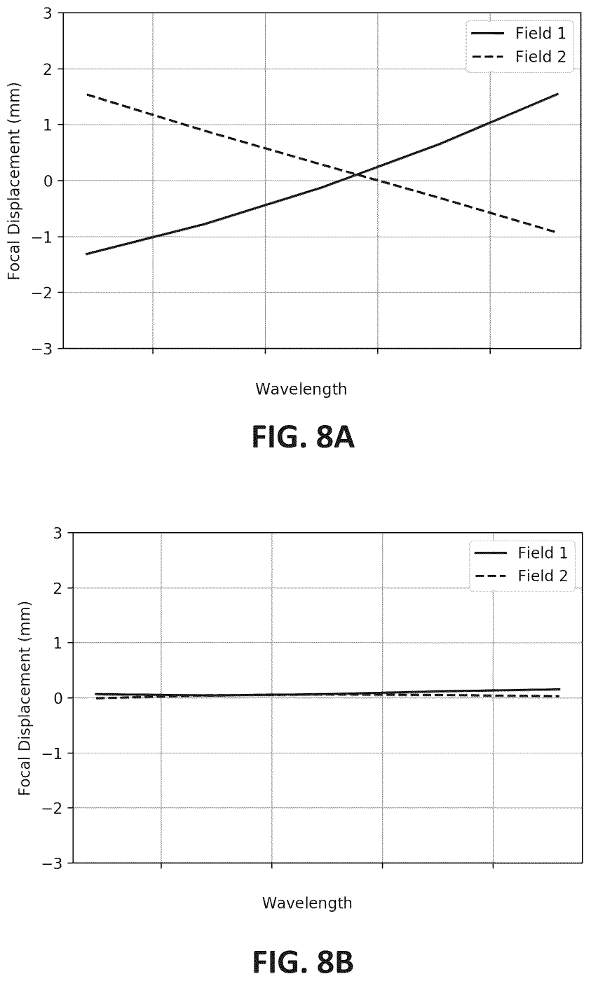

Referring now to FIGS. 8A and 8B, there are illustrated graphs of focus displacement from an image plane as a function of wavelength. In this particular example, the two fields represent two separate co-propagating beams, with each beam and each wavelength having a different focal point in the image domain. In an ideal system, all wavelengths and both fields are focused to a common image plane. FIG. 8A illustrates a conventional WSS system that does not include the modified phase profile of grism 22 or focusing lens 24 of the present disclosure. The solid and dashed lines represent the two co-propagating beams, both having a highly wavelength-dependent focal position. A single, central wavelength point is focused on the image plane while other wavelengths are focused far from the image plane.

FIG. 8B illustrates a modified WSS system in which the diffraction profile of grism 22 and focusing lens 24 of the present disclosure have been optimized for the specific system. As illustrated, the wavelength dependence is significantly reduced and all wavelengths are focused much closer to the image plane (displacement value of 0) than in the system of FIG. 8A.

In one embodiment, to determine the required grating profile which compensates for aberrations, method 900 of FIG. 9 is performed. Method 900 will be described with reference to device 10 of FIG. 4. However, it will be appreciated that method 900 can be applied to other optical systems that include a DOE.

At initial step 901, the required focal length, dispersion, and resolution of the optical device are determined. These parameters are typically specified by or required as a result of a particular application of the optical system. By way of example, the number and configuration of optical ports, the number of wavelength channels to be switched and the channel spacing would all determine the required focal length, dispersion, and resolution of the optical device.

Once these system requirements are specified, at step 902, the optical device is modeled using computer software such as the Radiant Zemax optical design software. In the model, at step 903, a reconfigurable phase surface is added in place of grism 22. In some modeling software, the phase surface can be implemented directly as a surface having phase properties that can be specified. In each case, the phase surface provides a reconfigurable two-dimensional phase profile, which can be varied to accommodate for optical aberrations in the device. Following insertion of the phase surface, various beam properties are measured at the LCOS switching device 20, such as the size, Gaussian nature (M²), and position of a beam waist.

In some embodiments, data on optical aberrations in a given optical system is obtained using a standard diffraction grating without aberration correction. The initial corrective phase profile is then determined as per U.S. Pat. No. 10,310,148 entitled “Systems and methods of aberration correction in optical systems”. This becomes the starting system for fine-tuning of the higher NA optical systems.

At step 904, from the measured beam information, M² values of the beam at LCOS device 20 (image plane) are calculated in the y-axis for desired wavelengths across the spectrum. M² is an optical beam quality measure defined as the ratio of the beam parameter product (BPP) of the measured beam to that of an ideal Gaussian beam. BPP is the product of the divergence angle of the optical beam (half-angle) and the radius of the beam at its narrowest point (the beam waist). The ideal case for a WSS system is to have M²=1 and the beam waist located at the image plane for all wavelengths and polarizations.

At step 905, a required amount of grating chirp (change in periodicity of diffracting elements across a grating) is estimated. The required grating chirp would create a wavelength-dependent focal length change that would correct the M² value of the beam at the image plane. The grating chirp is calculated using the following equation:

$$Grating Chirp = \frac{Δ k}{2 Δ f}$$

Where Δk represents the range of wavevector (2π/λ) to be imaged and Δf represents difference in position of the wavevectors at the image plane.

At step 906, the required radius of curvature (ROC) and optionally other parameters of lens 24 to collimate a central (or other arbitrary) wavelength is determined based on the estimated grating chirp in step 905. The ROC is calculated as follows:

$$R O C = \frac{k ( n - 1 )}{2 * Grating Chirp}$$

Where n is the refractive index of the glass used in lens 24.

At step 907, a mathematical optimization routine is implemented to minimize the M² values of the beam at the image plane obtained in step 904. This minimization process involves modifying the initially calculated grating chirp and ROC values to minimize for M². In some embodiments, the phase profile of the phase surface described in step 903 is represented as a combination of polynomials, and the phase profile is varied by modifying the weight terms of the polynomials. In some embodiments, the polynomials are linear polynomials of degree 1. In other embodiments, the phase profile is represented by other mathematical expressions and higher degree polynomials including Zernike polynomials. Example Zernike polynomials and an optimization routine is described in U.S. Pat. No. 10,310,148, which is incorporated herein by way of cross reference. In some embodiments, other minimization techniques are employed.

Along with modifying the weight terms for these polynomials, some optical path lengths in the device are also allowed to change within system calibration constraints during the optimization routine. This is done to maintain the beam waist location at the image plane. By minimizing the sum of M² values, the optimization procedure defines the system with the fewest aberrations at the image plane. This allows determining a phase profile of DOE 1 and lens characteristics of element 5.

At step 907, the characteristics of lens 24 and the phase profile (I) of DOE 22 are determined after optimization is completed.

In one embodiment, a polynomial series in (x,y) coordinates is used which gives rise to the following phase profile:

$$ϕ = M {\sum }_{i = 1}^{N} {A}_{i} {P}_{i} ( x , y ) c c$$

Wherein Aᵢ are the weights for each polynomial term Pᵢ. In this embodiment, Pᵢ=1, P₂=x, P₃=y, P₄=x², P₅=xy, P₆=y², P₇=x³ . . . etc. So phase corrections terms can easily be added in x, y, or both dimensions simply by changing the weight of any of these polynomial terms.

Referring still to FIG. 9, finally, at step 908, the phase profile (Φ) is translated into a corresponding DOE structure, where the shape and spacing of the individual diffractive elements are defined. The lens characteristics are used to specify lens 24.

The profile is written into the DOE 22 (or, in the case of another optical system, into the corresponding DOE) in a conventional manner such as photolithographic and mechanical etching techniques.

In some embodiments, the diffracting elements are arranged in a chirped arrangement wherein the period of the diffracting elements is not constant, but varies along the length of the DOE. A linearly chirped grating is one in which the variation in the period of the grating is linear along the length of the DOE.

The resulting diffractive grism 22 (or equivalent DOE) spatially disperses each wavelength channel and imposes phase changes to each channel to compensate for optical aberrations that are imposed on the beams before and after grism 22. The DOE optimization routine described above is also able to maintain the required dispersion of the spectrum, as well as control the spot size of the beam at the image plane.

### CONCLUSIONS

It will be appreciated that the disclosure above provides various systems and methods of aberration correction in optical systems.

In embodiments of the present disclosure, phase correction is incorporated into the DOE and a complementary lens in a WSS device is used to modify (e.g. at least partially reverse) the wavelength-dependent optical focusing of the wavelength components by the DOE. The phase correction is achieved by subtly changing the line spacing and curvature of the diffractive elements of the DOE as a function of position. The global optical focusing, as well as subtle wavelength dependence, can be modified to correct the system aberrations by defining the appropriate focusing of the lens in the system. The phase correction profile of the DOE provides a phase adjustment to the optical beams, undoing the aberrations already present, and pre-biasing negative aberrations for those that will be present later in the optical path. This aberration correction allows the focused spot at the image plane to be made smaller and more symmetric, leading to sharper channel profiles. Significantly, these improvements can be made with a small change to an existing optical device or system. Embodiments of the disclosure do not require a more complex WSS design, or additional corrective elements.

It will be appreciated that the techniques applied herein apply to optical elements other than the single diffraction grating typically used in a WSS. For example, in one embodiment, an optical element separate from the diffraction grating can be incorporated into a WSS and a modified phase profile etched into the element.

### Interpretation

Throughout this specification, the use of the term “optical” in the sense of optical signals, optical wavelengths, or the like is intended to refer to electromagnetic radiation in any one of the visible, infrared, or ultraviolet wavelength ranges.

Throughout this specification, the use of the term “element” is intended to mean either a single unitary component or a collection of components that combine to perform a specific function or purpose.

Throughout this specification, use of the term “orthogonal” is used to refer to a 90° difference in orientation when expressed in a Jones vector format or in a Cartesian coordinate system.

Throughout this specification, use of the terms “frequency” and “wavelength” are used interchangeably to represent a specific finite value, range or region, or channel in the frequency domain. For example, the mention of a frequency channel is equivalent to a wavelength channel even though the frequency of that channel will be numerically different from the wavelength of that channel. The actual frequency (f) and wavelength (λ) of an electromagnetic wave is related via the relationship ν=fλ, where ν is the velocity of the wave in space. The velocity is dependent on the parameters of the medium through which the electromagnetic wave is traveling. In a vacuum, the velocity of the wave approaches the speed of light.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

Reference throughout this specification to “one embodiment”, “some embodiments” or “an embodiment” means that a particular feature, structure, or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures, or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of, or which comprises is an open term that means including at least the elements/features that follow, but not excluding others. Thus, the term comprising, when used in the claims, should not be interpreted as being limitative to the means or elements, or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof to streamline the disclosure and aid in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures, and techniques have not been shown in detail in order not to obscure an understanding of this description.

Embodiments described herein are intended to cover any adaptations or variations of the present disclosure. Although the present disclosure has been described and explained in terms of particular exemplary embodiments, one skilled in the art will realize that additional embodiments can be readily envisioned that are within the scope of the present disclosure.

What is claimed is:

1. A wavelength dispersive optical system, comprising:
at least one optical input for projecting an input optical beam comprising a plurality of individual wavelength components;
at least one optical output for receiving one or more output optical beams;
a diffractive optical element (DOE) including a substrate and an array of physical diffraction elements, wherein the diffraction elements have a predefined spacing and/or curvature across a length of the DOE and wherein the diffraction elements are collectively adapted to:
spatially separate the individual wavelength components within the input optical beam to be formed into the one or more output optical beams;
impose predefined phase changes to the wavelength components to at least partially correct for optical aberrations to the input optical beam; and
impose predefined phase changes to the wavelength components to apply a wavelength-dependent optical focusing to at least some of the wavelength components; and
an optical focusing element having optical focusing properties complementary to the DOE to modify the wavelength-dependent optical focusing of the wavelength components imparted by the DOE.

2. The system according to claim 1 wherein the optical focusing element is adapted to modify the optical focusing of the wavelength components to at least partially reverse the optical focusing by the DOE.

3. The system according to claim 1 wherein the optical focusing element is adapted to provide wavelength-independent optical focusing of the wavelength components.

4. The system according to claim 1 wherein the optical focusing element is adapted to provide wavelength-dependent optical focusing of the wavelength components.

5. The system according to claim 1 wherein the optical focusing element is a cylindrical lens.

6. The system according to claim 1 wherein the optical focusing element is a spherical lens.

7. The system according to claim 1 wherein the optical focusing element is an aspherical lens.

8. The system according to claim 1 wherein the optical focusing element includes a freeform optical element.

9. The system according to claim 1 wherein the optical focusing element includes a second DOE.

10. The system according to claim 1 in the form of a wavelength selective switch.

11. The system according to claim 1 wherein the DOE provides a divergent optical focusing to the wavelength components and the optical focusing element provides a convergent optical focusing to the wavelength components.

12. The system according to claim 1 wherein the optical focusing element is located at a predefined position relative to the DOE.

13. The system according to claim 12 wherein the predefined position is chosen such that a particular one or more wavelength components are collimated by the optical focusing element.

14. The system according to claim 1 wherein the DOE is a diffraction grating.

15. The system according to claim 1 wherein the DOE is a grating-prism (grism) element.

16. The system according to claim 1 wherein the diffraction elements are arranged in a chirped configuration along the length of the DOE.
